(19) United States
(12) Patent Application Publication
(10) Pub. No.: US 2008/0140944 A1
(43) Pub. Date: Jun. 12, 2008

(54) Method and apparatus for storage resource management in plural data centers

(75) Inventors: Hiroshi Arakawa, Sunnyvale, CA (US); Yasunori Kaneda, San Jose, CA (US); Akira Yamamoto, Kanagawa (JP)

Correspondence Address: SUGHRUE MION, PLLC, 2100 Pennsylvania Avenue, N.W., Washington, DC, 20037, US

(73) Assignee: HITACHI, LTD., Tokyo (JP)

(21) Appl. No.: 11/638,010

(22) Filed: Dec. 12, 2006

(51) Int. Cl. G06F 13/14

(52) U.S. Cl. 711/148

(57) ABSTRACT

A controller in local site can process a request for storage resources from requestors like host computers, backup servers and tier manager. The controller checks own resource information including information about storage resources in the local site, according to requirements based on the request. The controller also asks other controllers in remote sites to check storage resources in each remote site. The controller in the local site collects the answers about available storage resources (including resources in the local site) under the requirements and selects storage resources to be used. Then the controller in the local site notifies the selected storage resources to the requester. Release of storage resource can also be performed with communication between controllers. Computers and backup servers can utilize these functions provided by the controllers to obtain and release the storage resources.

### DESCRIPTION OF THE INVENTION

1. Field of the Invention

This invention generally relates to storage technology and, more specifically, to method and apparatus for management of storage resources (e.g. volume or capacity) in plural sites.

2. Description of the Related Art

Recently, a lot of organizations extend their activity to wide area in a country, a continent or the world and these organizations have multiple branches at dispersed location in the area. In addition, many organizations posses multiple sites (data centers, branch office and remote office) that have storage systems providing storage resources like volume or area to store data. In many cases, these sites are connected each other via WAN or the internet. In this environment, storage resources in one site can be used by computers in other site via WAN by conventional technology like WAFS. These sites are also used to realize disaster recovery capability for the organization's data. Maintaining copy of the data by replication in separated site with enough distance avoids loss of the data even if a disaster (earthquake etc.) attacks one site. Currently, however, utilization of the resources is very low and management cost is very high because management and use of the storage resources are performed in each site independently. Especially, impact regarding path between sites is not considered automatically in the management.

In addition, conventional means to manage storage resources do not support tier management of storage resources and information life cycle management in multiple sites. In these management methods, in order to achieve appropriate placement of data and cost efficiency, storage resources are classified into multiple tiers based on resources' attribute like performance, reliability and cost of storage equipments. Data (contents) are also classified and put on one tier that is selected based on value of the data and requirements for the data. However, conventional method can not achieve tier management of storage resources in multiple sites because management and use of the storage resources are performed in each site independently.

Moreover, conventional methods to deal with failure information (failure messages) generated in remote site have a problem. With conventional methods, transferring these messages may be delayed because the messages are transferred with a large amount of other information via same LAN and WAN used by computers in the remote site, however such failure messages should be transferred exclusively with priority.

Thus, current technology is deficient in its ability to provide integrated management environment for storage resources in multiple sites and to achieve tier management of storage resources in multiple sites in consideration of influence of path between sites. Finally, existing systems are unable to manage failure information between sites with priority.

### SUMMARY OF THE INVENTION

The inventive methodology is directed to methods and systems that substantially obviate one or more of the above and other problems associated with conventional techniques for management of storage resources.

In accordance with an aspect of the inventive methodology, there is provided a computerized storage system and the associate method. The inventive system includes at least one local storage resource; a network interface operable to connect the computerized storage system with at least one requestor and a storage controller. The storage controller is configured to: receive a request for storage resources from the at least one requester, the request comprising at least one storage resource requirement; check resource information including information about the at least one local storage resource according to the at least one storage resource requirement; issue secondary request for storage resources to at least one remote controller at a remote site to check storage resources at the remote site; collect a reply from the at least one remote controller about available storage resources at the remote site according to the at least one storage resource requirement; select storage resources to be used from the at least one local storage resource and available storage resources at the remote site; and notify the at least one requestor of the select storage resources.

In accordance with another aspect of the inventive methodology, there is provided a storage controller. The inventive controller is configured to: receive a request for storage resources from at least one requester, the request comprising at least one storage resource requirement; check resource information including information about at least one local storage resource according to the at least one storage resource requirement; issue secondary request for storage resources to at least one remote controller at a remote site to check storage resources in the remote site; collect at least one reply from the at least one remote controller about available storage resources at a remote site according to the at least one storage resource requirement; select storage resources to be used from the at least one local storage resource and available storage resources at a remote site; and notify the at least one requestor of the select storage resources.

In accordance with yet another aspect of the inventive methodology, there is provided a method for managing location of data in multiple sites. The inventive method involves determining data to be moved to optimize data location; determining requirements of necessary storage resource for new location of the data; obtaining necessary storage resources using the determined requirements by selecting the necessary storage resources from the at least one local storage resource and available storage resources at a remote site; moving the data to the obtained storage resource; changing mapping information for the data; and releasing an old storage resource corresponding to old location of the data.

In accordance with further aspect of the inventive methodology, there is provided a storage controller. The inventive controller is configured to receive a failure message from at least one device in a local site; choose a destination controller from at least one controller in the local site and at least one controller in a remote site; and transfer the failure message to the destination controller using a data transfer path dedicated storage system if the destination controller is located in the remote site.

In accordance with yet further aspect of the inventive methodology, there is provided a method for processing a failure message from device. The inventive method involves: receiving a failure message from at least one device in a local site; choosing a destination controller from at least one controller in the local site and at least one controller in a remote sites; and transferring the failure message to the destination controller using a data transfer path dedicated storage system if the destination controller is located in the remote site.

In accordance with yet further aspect of the inventive methodology, there is provided a graphical user interface. The inventive interface is configured to: display a first category showing types of storage resources; display the second category showing each site of a plurality of sites; and show information about storage resources from the first category perspective to the second category.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 describes exemplary system including multiples sites.

FIG. 2 describes one example of system configuration in a site.

FIG. 3 illustrates exemplary configuration of controller.

FIG. 4 illustrates exemplary resource information.

FIG. 5 illustrates exemplary usage information.

FIG. 6 illustrates exemplary path information.

FIG. 7 illustrates exemplary tier specification information.

FIG. 8 illustrates exemplary mapping information.

FIG. 9 illustrates exemplary process for obtaining storage resource for host computer.

FIG. 10 illustrates exemplary process for releasing storage resource associated with host computer.

FIG. 11 illustrates exemplary process for obtaining storage resource for backup server.

FIG. 12 illustrates exemplary process for releasing storage resource associated with backup software.

FIG. 13 illustrates exemplary process for obtaining and releasing storage resource for tier management of storage.

FIG. 14 illustrates exemplary process for obtaining storage resource by controllers in sites.

FIG. 15 illustrates exemplary process for releasing storage resource by controllers in sites.

FIG. 16 illustrates exemplary process for transferring failure information.

FIG. 17 shows an example of management panel (GUI).

FIG. 18 shows another example of management panel (GUI).

FIG. 19 shows another example of management panel (GUI).

FIG. 20 shows another example of management panel (GUI).

FIG. 21 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In an embodiment of the invention, a controller in local site can process a request for storage resources from requestors like host computers, backup servers and tier manager. The controller checks own resource information including information about storage resources in the local site, according to requirements based on the request. The controller also asks other controllers in remote sites to check storage resources in each remote site. The controller in the local site collects the answers about available storage resources (including resources in the local site) under the requirements and selects storage resources to be used. After that, the controller in the local site notifies the selected storage resources to the requester. Release of storage resource can also be performed with communication between controllers. Computers and backup servers can utilize these functions provided by the controllers to obtain and release the storage resources.

Several types of integrated management view (GUI) are provided in one embodiment of the invention. In an exemplary embodiment, various information regarding storage resources in multiple sites is shown with an integrated style in one window.

As for tier management of storage resources, in order to change location of data according to change of requirements for the data, tier management function can use the functions mentioned above to obtain new location of the data and to release old location of the data. Thus, optimization of data location between multiple sites can be performed. Generally, the change of the requirements for the data is acquired from the change of the data's value, utilization, access rate, length of life and so on.

In one embodiment of the invention, in order to transfer failure messages with priority, controller receives a failure message (e.g. SNMP trap) generated by a storage device, checks the destination of the message, transfers the message to remote site via SAN and WAN (path for storage access) if the destination is remote site. The message received by a controller in the remote site is sent to management terminal in the remote site via LAN as well as an ordinary failure message.

Various embodiment of the invention will now be described in detail.

### 1. Overview of System Including Multiple Sites

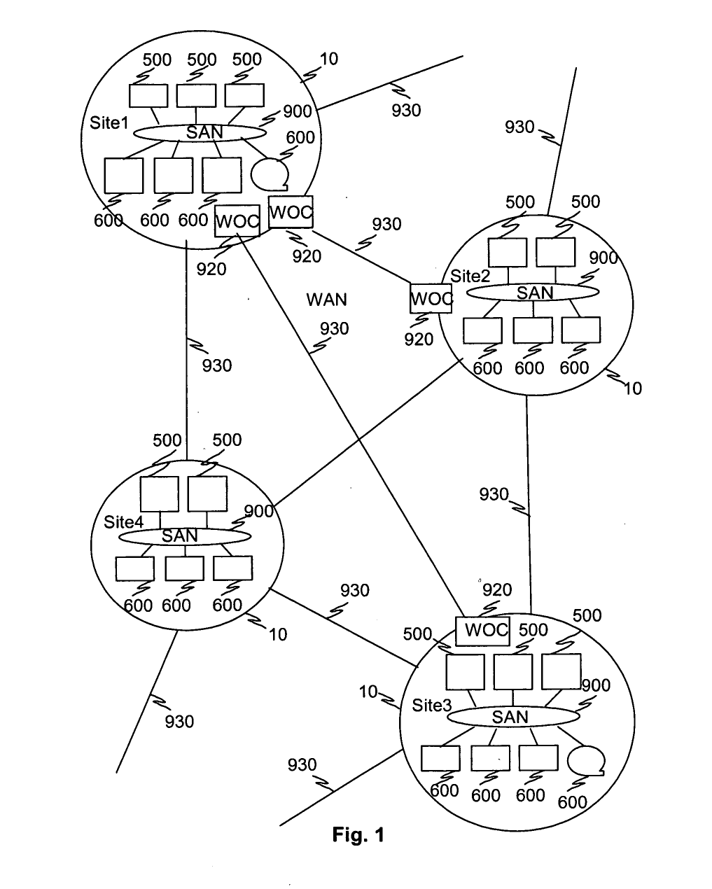

FIG. 1 illustrates one exemplary embodiment of a system including multiples sites. The shown system includes Site 10, which can be a data center, remote office, branch office and the like. Many organizations may posses such sites at dispersed location. These sites are also used to realize disaster recovery capability for the organization's data. Maintaining copy of the data by replication in separated site with enough distance avoids loss of the data even if a disaster (earthquake etc.) attacks one site. The system further includes Host computer 500, Storage device 600, which can be a disk, NAS, tape, or a flash memory. The shown system also contains SAN 900, WAN Optimization Controller (WOC) 920 and WAN 930.

The SAN 900 connects Host computers 500 and Storage devices 600 each other. SAN 900 can be implemented using Fibre Channel, iSCSI and other similar communication protocols. WAN 930 connects Sites 10 including computer resources like Host computer 500 and storage devices 600 each other. WOC 920 is a gateway device that decreases and optimizes transferring of data between sites by using technique like deduplication, compression and caching. WOC 920 is connected to WAN 930 and the computer resources in Site 10.

### 2. System Configuration in a Site

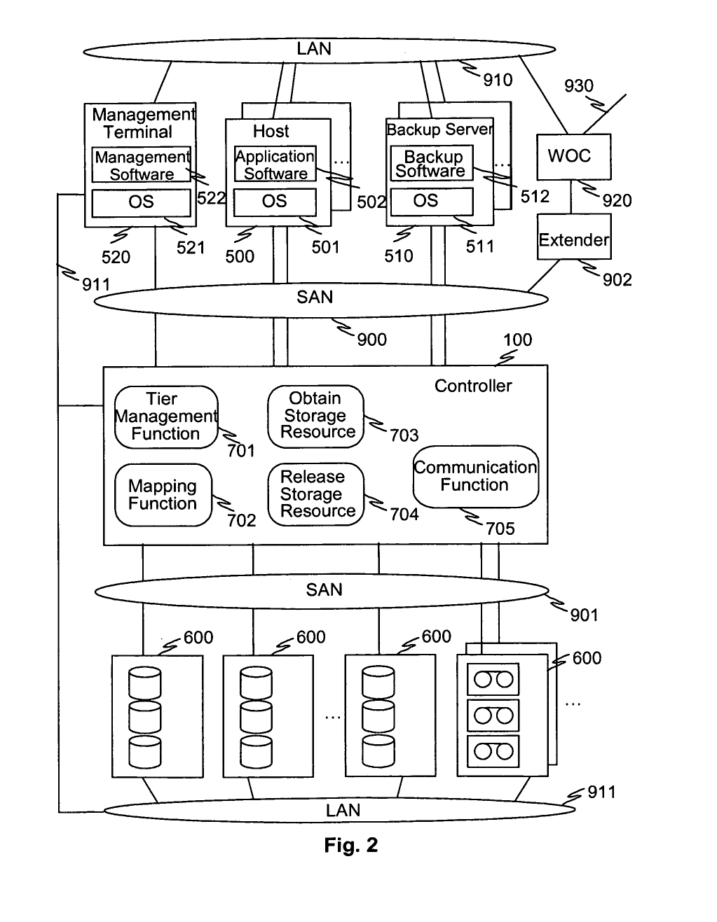

FIG. 2 depicts one example of configuration of a Site 10. Specifically, the Site 10 may include Controller 100, Host computer 500, OS 501, Application software 502, Backup server 510, OS 511, Backup software 512, Management terminal 520, OS 521, Management software 522, and Storage device 600, which may be a disk, NAS, tape, flash memory or the like.

The site 10 may further include SAN 900, SAN 901, Extender 902, LAN 910, LAN 911, WOC 920 and WAN 930. Host computer 500, Backup server 510 and Management Terminal 520 have processors, memory and other means to work Application software 502, Backup software 512 and Management software 522, OS and other processes.

SAN 900 and SAN 901 connect the above computers, Controller 100 and Storage devices 600. SAN 900 and SAN 901 can be implemented using FC and iSCSI protocols. LAN 910 connects Host computer 500, Backup server 510 and Management Terminal 520. LAN 911 connects Storage devices 600, Controller 100 and Management Terminal 520. LAN 910 connects to WOC 920 and/or WAN 930. SAN 900 connects to WOC 920 and/or WAN 930 via Extender 902.

Controller 100 incorporates Tier management function 701, Mapping function 702 and Communication function 705. In addition, Controller 100 is operable to Obtain storage resource 703 and Release storage resource 704.

Controller 100 can communicate Host computer 500, Backup server 510, Management Terminal 520 and other Controllers 100 in other Sites 10 by using Communication function 705. Mapping function provides logical storage resource (e.g. volume or capacity) generated by virtualization of resources of Storage devices 600.

Details of the functions will be described bellow.

### 3. Configuration of Controller 100

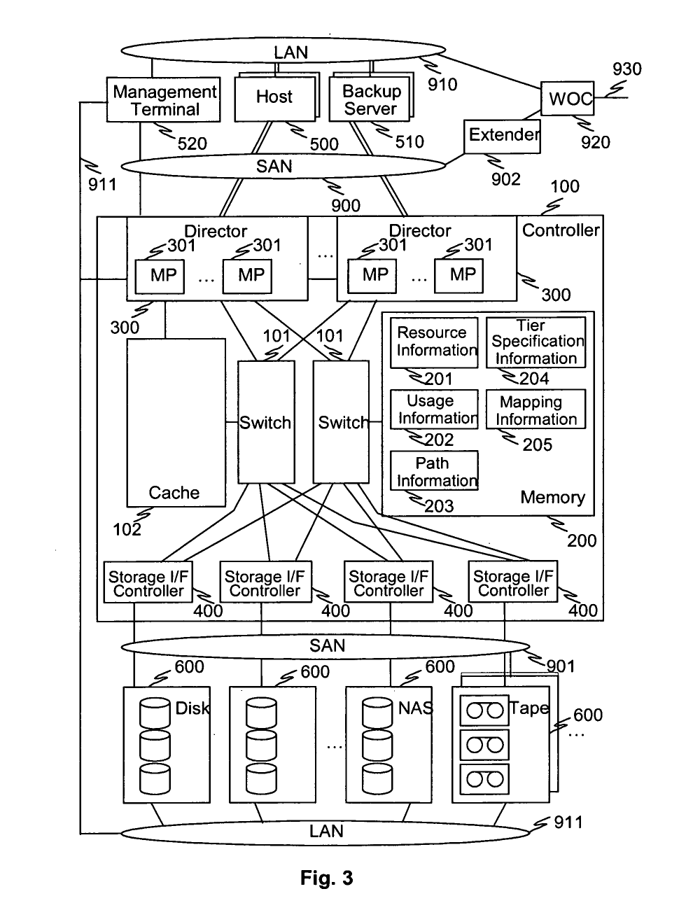

FIG. 3 illustrates the configuration of the Controller 100. Specifically, the Controller 100 incorporates Switch 101, Cache 102, Memory 200, Director 300, Main Processor (MP) 301, and Storage interface (I/F) controller 400. FIG. 3 also shows Host computer 500, Backup server 510, Management terminal 520, Storage device (e.g. disk, NAS, tape, flash memory) 600, SAN 900, SAN 901, Extender 902, LAN 910, LAN 911, WOC 920 and WAN 930.

Main processors 301 perform various processes associated with Controller 100. Main processor 301 and other components uses following information stored in Memory 200. This information will be mentioned in the explanation of some process described later. Specifically, Memory 200 stores Resource information 201, Usage information 202, Path information 203, Tier specification information 204, and Mapping information 205.

Host computer 500, Backup server 510 and Management Terminal 520 are connected to Director 300 via SAN 900.

### 4. Operation by Host Computer

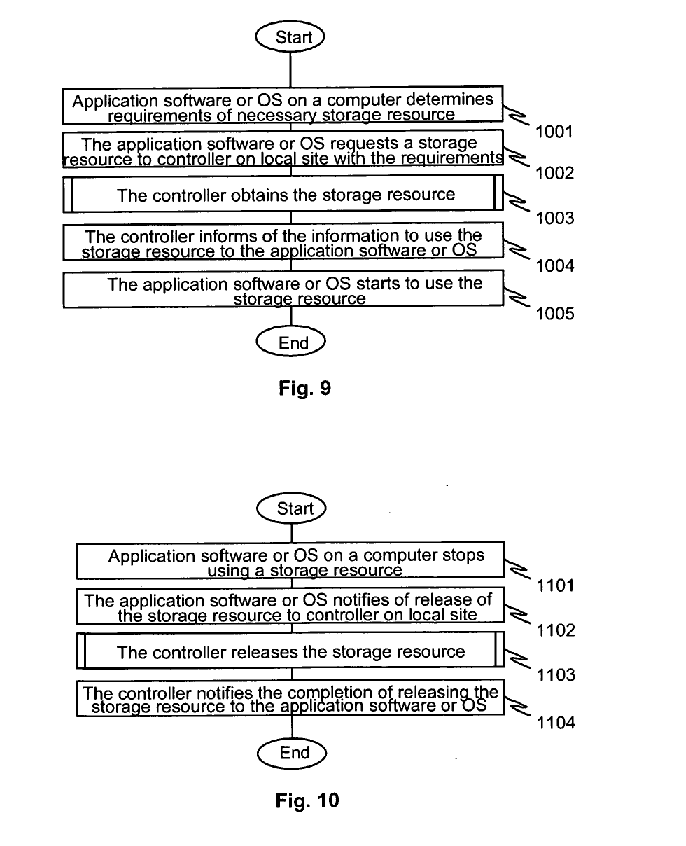

FIG. 9 shows a process for obtaining storage resource for Host computer 500. Application software 502 or OS 501 on Host computer 500 obtains storage resource (e.g. volume or capacity) when it has to store data newly, for example.

At step 1001, Application software 502 or OS 501 determines requirements of necessary storage resource. The requirements include type of storage and may include target of response time, throughput, capacity, method of protection, other storage function like snapshot function, and so on. As another example, the requirements may include condition about distance, especially in view of disaster recovery. For example, as location of copy of data, storage resource that is separate from local site at least X Km is required to avoid simultaneous failure by one disaster.

At step 1002, Application software 502 or OS 501 requests a storage resource to Controller 100 on local site with the above requirements.

At step 1003, the Controller 100 obtains the storage resource. Detailed process of this step will be described later.

At step 1004, the Controller 100 informs of the information to use the obtained storage resource to the Application software 502 or OS 501.

At step 1005, the Application software 502 or OS 501 begins to use the storage resources based on the informed information.

FIG. 10 shows a process of releasing storage resource regarding Host computer 500. Releasing unused storage resources makes storage usage efficiency better because other software becomes be able to use the storage resource.

At step 1101, Application software 502 or OS 501 stops using a storage resource.

At step 1102, the Application software 502 or OS 501 notifies of release of the storage resource to Controller 100 on local site.

At step 1103, the Controller 100 releases the storage resource. Detailed process of this step will be described later.

At step 1104, the Controller 100 notifies the completion of releasing the storage resource to the Application software 502 or OS 501.

### 5. Operation for Backup Process

FIG. 11 shows a process of obtaining storage resource for Backup server 510. Backup software 512 on Backup server 510 obtains storage resource (e.g. volume or capacity) when backup process of data is prepared, for example.

At step 1201, Backup software 512 determines requirements of necessary storage resource. The requirements include type of storage and may include target of response time, throughput, capacity, method of protection, other storage function like WORM (Write Once Read Many) function, and so on. As another example, the requirements may include condition about distance, especially in view of disaster recovery. For example, as location of copy of data, storage resource that is separate from local site at least X Km is required to avoid simultaneous failure by one disaster.

At step 1202, Backup software 512 requests a storage resource to Controller 100 on local site with the above requirements.

At step 1203, the Controller 100 obtains the storage resource. Detailed process of this step will be described later.

At step 1204, the Controller 100 informs of the information to use the obtained storage resource to the Backup software 512.

At step 1205, the Backup software 512 begins transferring the backup data to the storage resources based on the informed information.

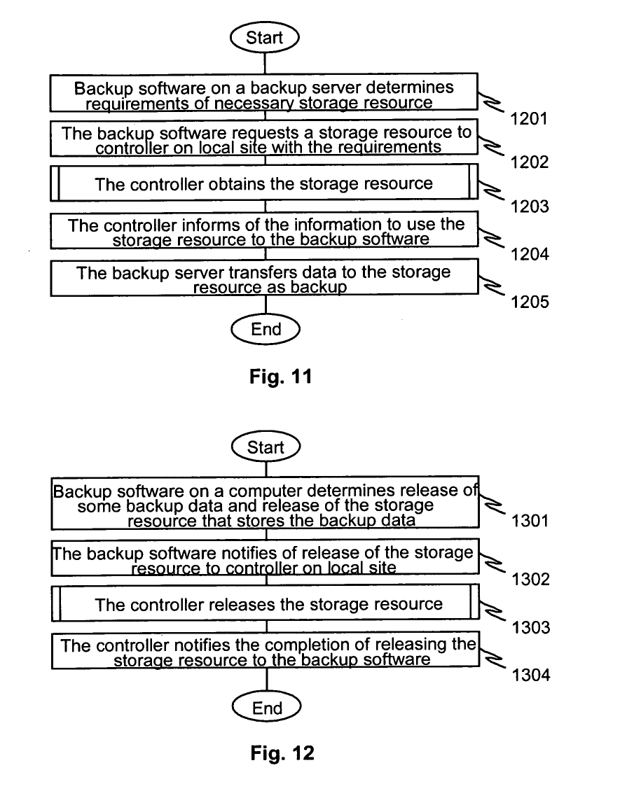

FIG. 12 shows a process of releasing storage resource regarding Backup software 502.

At step 1301, Backup software 512 determines release of some backup data and release of the storage resource that stores the backup data.

At step 1302, the Backup software 512 notifies of release of the storage resource to Controller 100 on local site.

At step 1303, the Controller 100 releases the storage resource. Detailed process of this step will be described later.

At step 1304, the Controller 100 notifies the completion of releasing the storage resource to the Backup software 512.

### 6. Operation for Tier Management

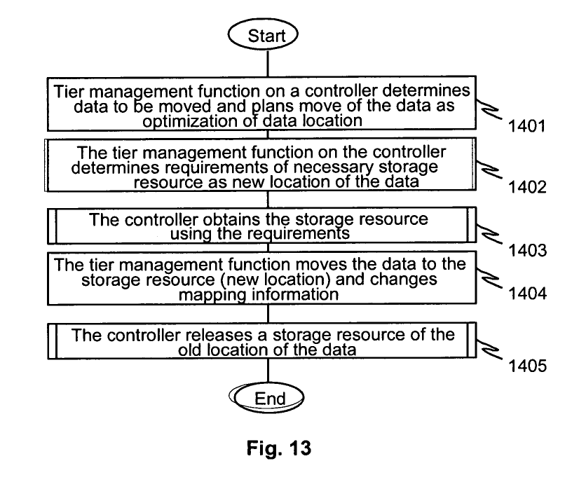

FIG. 13 illustrates a process for obtaining and releasing storage resource for tier management of storage. In tier management, Tier management function 701 plans to appropriate placement of data regularly according to change of value of the data and requirements of the data, and changes location of the data (i.e. moves the data). In this procedure, new location of the data is selected (obtained) and old data location is released.

At step 1401, Tier management function 701 determines data to be moved and plans move of the data as optimization of data location.

At step 1402, the Tier management function 701 determines requirements of necessary storage resource as new location of the data.

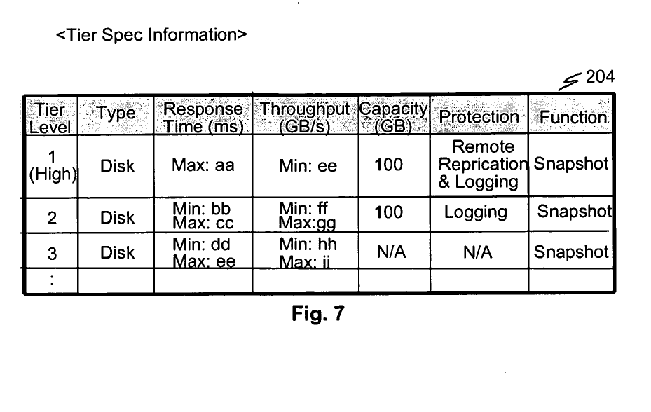

As for methods to plan appropriate placement and to select the new location of the data, several conventional methods are known. In this process, information like Tier specification information 204 in described in FIG. 7 is used. Tier specification information 204 has specification (requirement) information about each tier (group of storage resources) like type, response time, throughput, capacity, method of protection, other storage function, for example. The requirements for new location of the data include type of storage and may include target of response time, throughput, capacity, method of protection, other storage function, and so on.

At step 1403, the Controller 100 obtains the storage resource based on the requirements. Detailed process of this step will be described later.

At step 1404, the Tier management function 701 moves (or copies) the data to the storage resource (i.e. new location) and updates Mapping information 205.

At step 1405, the Controller 100 releases a storage resource of the old location of the data. Detailed process of this step will be described later.

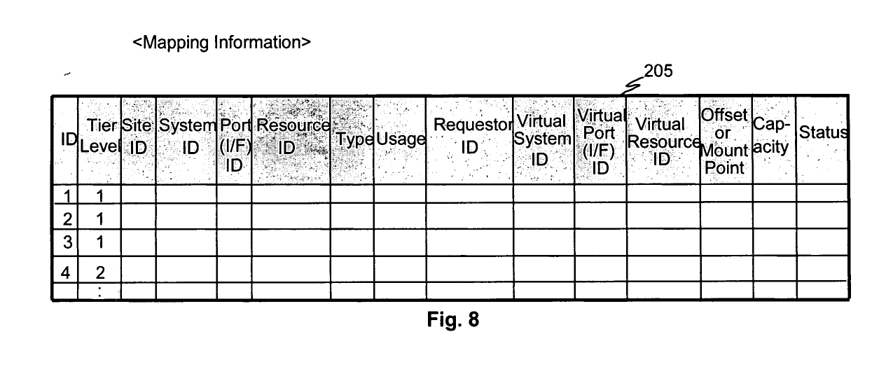

Mapping information 205 described in FIG. 8 has information about relation between storage resources provided by the Controller 100 (virtual storage resources) and actual storage resources in multiple sites. In FIG. 8, for example, this table has information about actual storage resources including Site ID, type, usage (“In use” or “Free” (i.e. not used)), Requestor ID, information about virtual storage resources, Offset and Mount point between actual and virtual storage resources, capacity and status (“Normal” and “In failure”). The Requestor ID is ID for requestor or user of the storage resources (e.g. ID of Application software 502, OS 501/511, Host computer 500, Backup software 512, Backup server 510 and so on).

Generally, Tier management function 701 can be located in Management terminal 520, Host computer 500 and other computer (not shown in the figures) and can communicate Controller 100 however it is in the Controller 100 in this embodiment.

### 7. Process of Obtaining Storage Resource

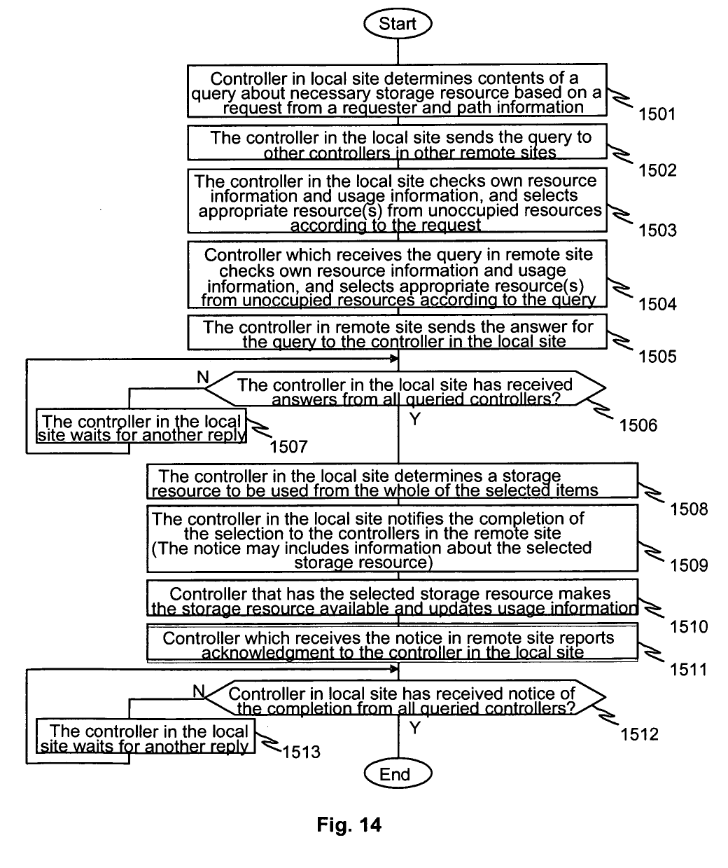

FIG. 14 shows a process of obtaining storage resource by Controllers 100 in Sites 10 mentioned above.

At step 1501, Controller 100 in local site determines contents of a query about necessary storage resources based on a request from a requestor and Path information 203.

Path information 203 described in FIG. 6 has information regarding other remote Site 10 and information regarding paths between the local site and the remote sites like availability (quality) of path, distance, delay, bandwidth, switching time between alternative paths, availability and specification of WOC, status (“Normal” or “In failure”) and so on. The Controller 100 in the local site can acquire true requirements as the contents of the query from a request from a requestor and Path information 203 (e.g. by decreasing delay from response time).

At step 1502, the Controller 100 in the local site sends the query to other controllers in other remote sites.

At step 1503, the Controller 100 in the local site checks own Resource information 201 and Usage information 202. Then the Controller 100 in the local site selects appropriate resource(s) from free (unoccupied) resources according to the request.

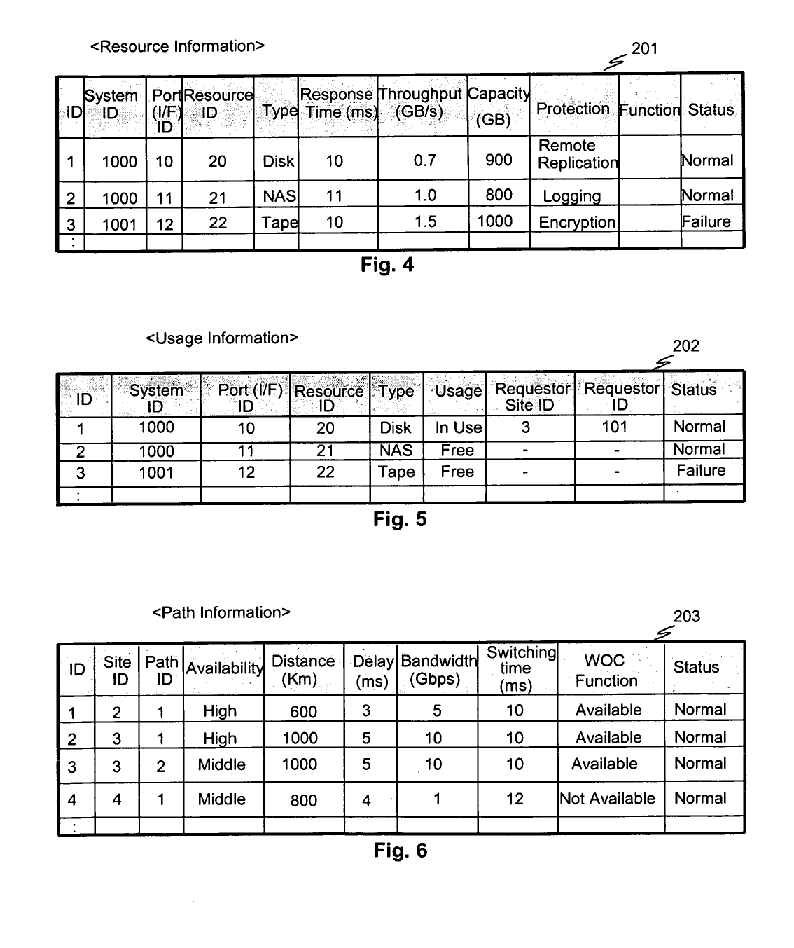

Resource information 201 described in FIG. 4 has information regarding storage resources in the Site 10. Usage information 202 described in FIG. 5 has information regarding usage (“In Use” or “Free”) of the storage resources in the Site 10. Usage information 202 can also has information about user of the resources like Site ID of the requestor and Requestor ID, for example.

At step 1504, in the remote site, the Controller 100 checks Resource information 201 and Usage information 202. Then the Controller 100 selects appropriate resource(s) from free (unoccupied) resources according to the request. This step can be performed in parallel with step 1503 and/or step 1505.

At step 1505, the Controller 100 in the remote site sends the answer for the query to the Controller 100 in the local site.

At step 1506 and step 1507, the Controller 100 in the local site waits for receiving the answers from all queried Controllers 100.

At step 1508, the Controller 100 in the local site determines a storage resource to be used from the whole of the selected items (candidates).

At step 1509, the Controller 100 in the local site notifies the completion of the selection to Controllers 100 in the remote site. The notice includes information about the selected storage resource if the selected storage resource is in the remote site and the notice is to be sent to the remote site.

At step 1510, the Controller 100 that has the selected storage resource makes the storage resource available. This process may include assignment and/or change of path in the site. In addition, the Controller 100 updates Usage information 202.

At step 1511, the Controller 100 which receives the notice in remote site reports acknowledgment to the Controller 100 in the local site.

At step 1512 and step 1513, the Controller 100 in the local site waits for receiving the acknowledgment from all queried Controllers 100.

### 8. Process of Releasing Storage Resource

FIG. 15 shows a process of releasing storage resource by Controllers 100 in Sites 10 mentioned above.

At step 1601, Controller 100 in local site checks the location of the storage resource to be released. If the storage resource is in local site, the process proceeds to step 1602. If the storage resource is in remote site, the process proceeds to step 1603.

At step 1602, the Controller 100 in the local site updates Usage information 202 to release the storage resources.

At step 1603, the Controller 100 in the local site notifies release of the storage resource to the Controller 100 in remote site that has the storage resource to be released.

At step 1604, the Controller 100 that receives the notice updates Usage information 202 to release the storage resource. Then the Controller 100 in the remote site reports completion of the update to the Controller 100 in the local site.

At step 1605, the Controller 100 in the local site receives the notice of the completion.

### 9. Process of Transferring Failure Information

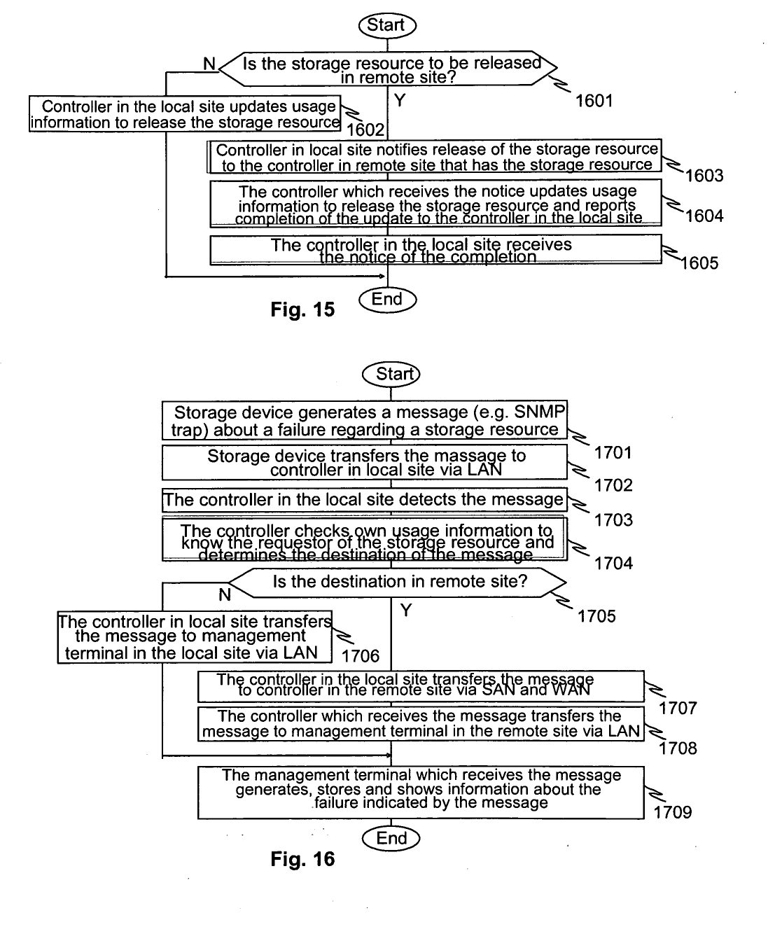

FIG. 16 shows a process of transferring failure information. In this embodiment, transferring failure information (e.g. SNMP trap message) between Site 10 is performed via paths on SAN 900 and WAN 930 dedicated to Controllers 100 to avoid using jammed route (coexisting with a number of communication to computers) and delay.

At step 1701, Storage device 600 generates a message about a failure regarding storage resource.

At step 1702, the Storage device 600 transfers the message to Controller 100 in local site of the Storage device 600 via LAN 911.

At step 1703, the Controller 100 in the local site detects the message.

At step 1704, the Controller 100 checks own Usage information 202 to know the requestor of the storage resource. Then the Controller 100 determines the destination of the message.

At step 1705, if the destination is in the local site, the process proceeds to step 1706. If the destination is in remote site, the process proceeds to step 1707.

At step 1706, the Controller 100 in the local site transfers the message to Management terminal 520 in the local site via LAN 911. Then the process proceeds to step 1710.

At step 1707, the controller 100 in the local site transfers the message to Controller 100 in the remote site via SAN 900 and WAN 930.

At step 1708, the Controller 100 that receives the message transfers the message to Management terminal 520 in the remote site via LAN 911.

At step 1709, the Management terminal 520 that receives the message generates stores and shows information about the failure indicated by the message.

### 10. Integrated Management Panel

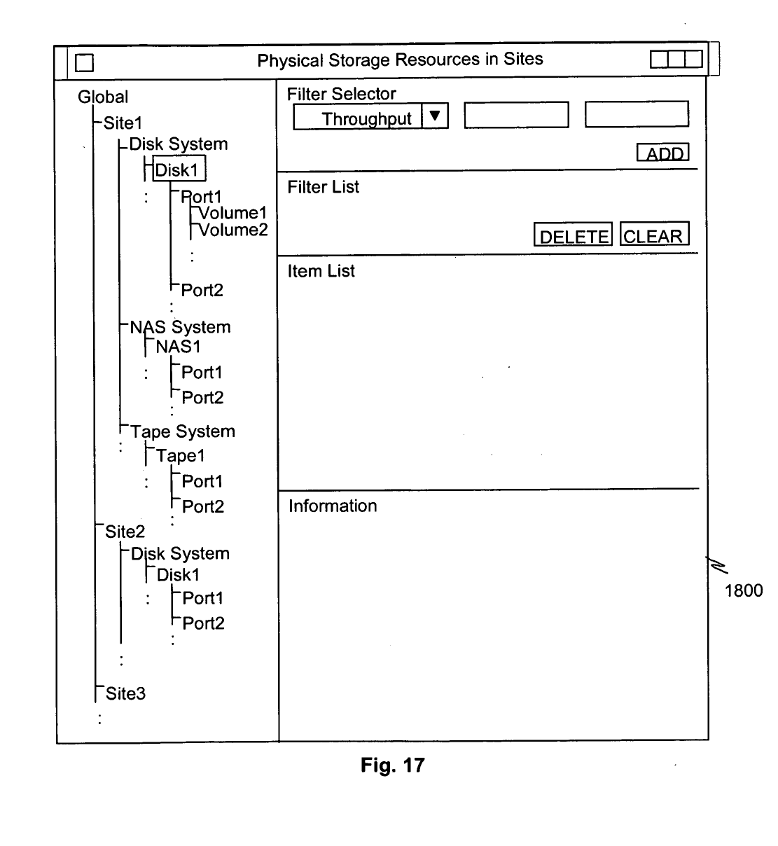

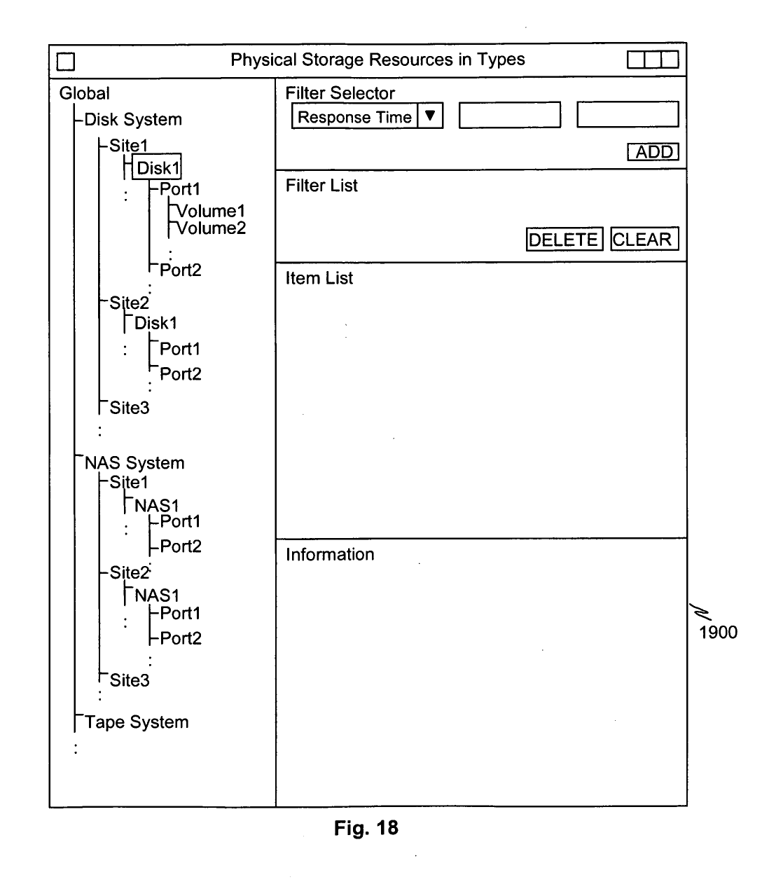

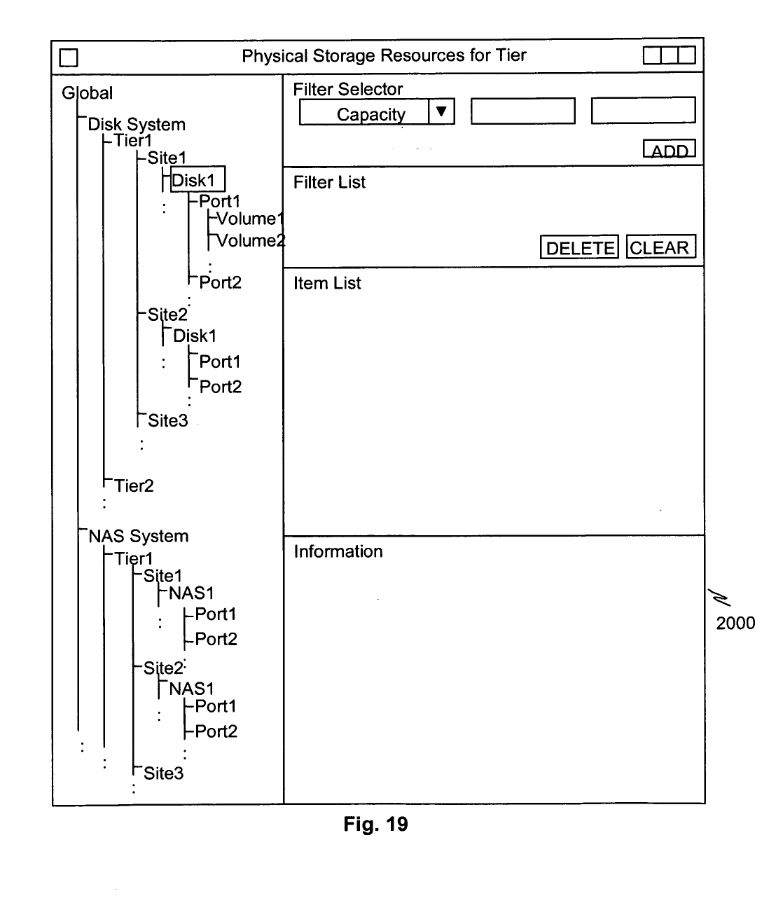

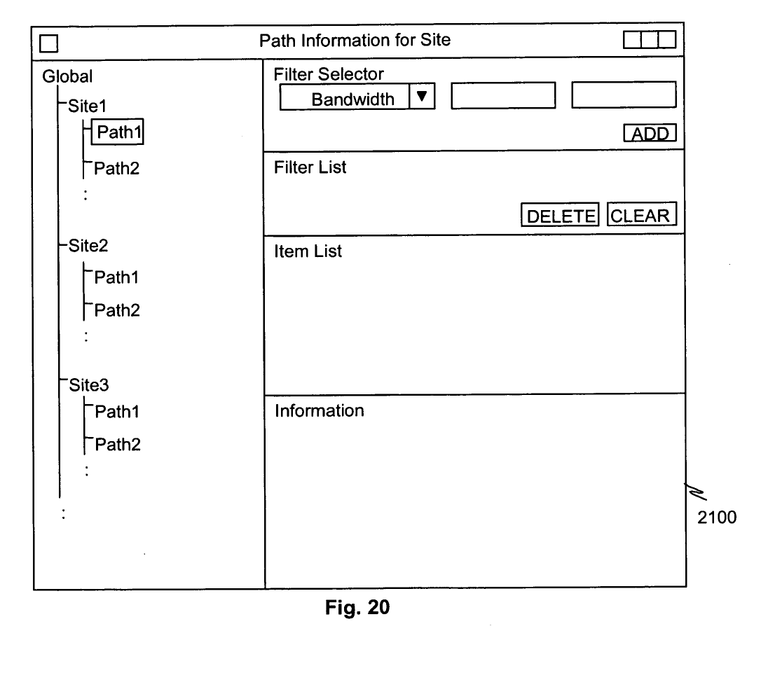

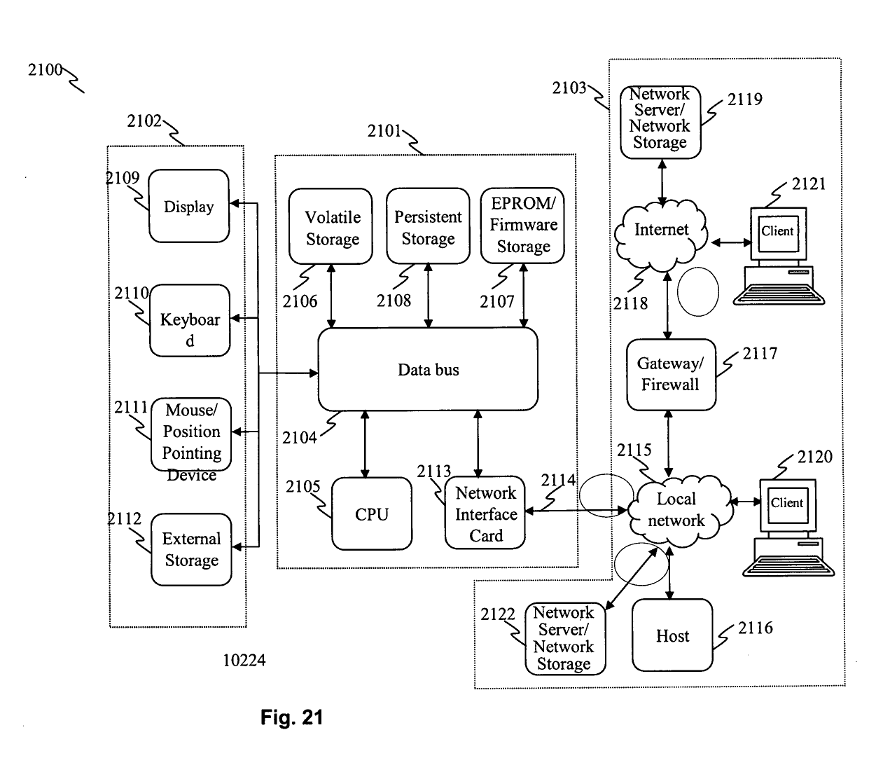

FIGS. 17, 18, 19 and 20 show examples of management panel (GUI) 1800, 1900, 2000 and 2100. Controller 100 communicates with other Controller 100 in other Sites 10, collects information and generates information for management. Controller 100 exchanges the information with Management terminal 520 and/or other computers. The management terminal 520 and/or other computers proved these management panels.

The example of panel has left part and right part. Left part shows a tree of items based on category. Right part shows information about item selected in the left part. Right part has “Filter Selector” part, “Filter List” part, “Item List” part and “Information” part. Using “Filter Selector”, a user or a manager can add condition to filter item to be displayed. The filter conditions are shown in “Filter List”, and a user or a manager can also delete and clear the condition from this list. “Item List” shows sub-items regarding the item selected in the left part. “Information” shows information regarding the item selected in the left part.

Generally, Controller 100 can be located in Management terminal 520, Host computer 500 and other computer (not shown in the figures). Controller 100 can be also integrated with Storage device 600.

### 11. Description of Exemplary Computer Platform

FIG. 21 is a block diagram that illustrates an embodiment of a computer/server system 2100 upon which an embodiment of the inventive methodology may be implemented. The system 2100 includes a computer/server platform 2101, peripheral devices 2102 and network resources 2103.

The computer platform 2101 may include a data bus 2104 or other communication mechanism for communicating information across and among various parts of the computer platform 2101, and a processor 2105 coupled with bus 2101 for processing information and performing other computational and control tasks. Computer platform 2101 also includes a volatile storage 2106, such as a random access memory (RAM) or other dynamic storage device, coupled to bus 2104 for storing various information as well as instructions to be executed by processor 2105. The volatile storage 2106 also may be used for storing temporary variables or other intermediate information during execution of instructions by processor 2105. Computer platform 2101 may further include a read only memory (ROM or EPROM) 2107 or other static storage device coupled to bus 2104 for storing static information and instructions for processor 2105, such as basic input-output system (BIOS), as well as various system configuration parameters. A persistent storage device 2108, such as a magnetic disk, optical disk, or solid-state flash memory device is provided and coupled to bus 2101 for storing information and instructions.

Computer platform 2101 may be coupled via bus 2104 to a display 2109, such as a cathode ray tube (CRT), plasma display, or a liquid crystal display (LCD), for displaying information to a system administrator or user of the computer platform 2101. An input device 2110, including alphanumeric and other keys, is coupled to bus 2101 for communicating information and command selections to processor 2105. Another type of user input device is cursor control device 2111, such as a mouse, a trackball, or cursor direction keys for communicating direction information and command selections to processor 2104 and for controlling cursor movement on display 2109. This input device typically has two degrees of freedom in two axes, a first axis (e.g., x) and a second axis (e.g., y), that allows the device to specify positions in a plane.

An external storage device 2112 may be connected to the computer platform 2101 via bus 2104 to provide an extra or removable storage capacity for the computer platform 2101. In an embodiment of the computer system 2100, the external removable storage device 2112 may be used to facilitate exchange of data with other computer systems.

The invention is related to the use of computer system 2100 for implementing the techniques described herein. In an embodiment, the inventive system may reside on a machine such as computer platform 2101. According to one embodiment of the invention, the techniques described herein are performed by computer system 2100 in response to processor 2105 executing one or more sequences of one or more instructions contained in the volatile memory 2106. Such instructions may be read into volatile memory 2106 from another computer-readable medium, such as persistent storage device 2108. Execution of the sequences of instructions contained in the volatile memory 2106 causes processor 2105 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 2105 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 2108. Volatile media includes dynamic memory, such as volatile storage 2106. Transmission media includes coaxial cables, copper wire and fiber optics, including the wires that comprise data bus 2104. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 2105 for execution. For example, the instructions may initially be carried on a magnetic disk from a remote computer. Alternatively, a remote computer can load the instructions into its dynamic memory and send the instructions over a telephone line using a modem. A modem local to computer system 2100 can receive the data on the telephone line and use an infra-red transmitter to convert the data to an infra-red signal. An infra-red detector can receive the data carried in the infra-red signal and appropriate circuitry can place the data on the data bus 2104. The bus 2104 carries the data to the volatile storage 2106, from which processor 2105 retrieves and executes the instructions. The instructions received by the volatile memory 2106 may optionally be stored on persistent storage device 2108 either before or after execution by processor 2105. The instructions may also be downloaded into the computer platform 2101 via Internet using a variety of network data communication protocols well known in the art.

The computer platform 2101 also includes a communication interface, such as network interface card 2113 coupled to the data bus 2104. Communication interface 2113 provides a two-way data communication coupling to a network link 2114 that is connected to a local network 2115. For example, communication interface 2113 may be an integrated services digital network (ISDN) card or a modem to provide a data communication connection to a corresponding type of telephone line. As another example, communication interface 2113 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 2113 sends and receives electrical, electromagnetic or optical signals that carry digital data streams representing various types of information.

Network link 2113 typically provides data communication through one or more networks to other network resources. For example, network link 2114 may provide a connection through local network 2115 to a host computer 2116, or a network storage/server 2117. Additionally or alternatively, the network link 2113 may connect through gateway/firewall 2117 to the wide-area or global network 2118, such as an Internet. Thus, the computer platform 2101 can access network resources located anywhere on the Internet 2118, such as a remote network storage/server 2119. On the other hand, the computer platform 2101 may also be accessed by clients located anywhere on the local area network 2115 and/or the Internet 2118. The network clients 2120 and 2121 may themselves be implemented based on the computer platform similar to the platform 2101.

Local network 2115 and the Internet 2118 both use electrical, electromagnetic or optical signals that carry digital data streams. The signals through the various networks and the signals on network link 2114 and through communication interface 2113, which carry the digital data to and from computer platform 2101, are exemplary forms of carrier waves transporting the information.

Computer platform 2101 can send messages and receive data, including program code, through the variety of network(s) including Internet 2118 and LAN 2115, network link 2114 and communication interface 2113. In the Internet example, when the system 2101 acts as a network server, it might transmit a requested code or data for an application program running on client(s) 2120 and/or 2121 through Internet 2118, gateway/firewall 2117, local area network 2115 and communication interface 2113. Similarly, it may receive code from other network resources.

The received code may be executed by processor 2105 as it is received, and/or stored in persistent or volatile storage devices 2108 and 2106, respectively, or other non-volatile storage for later execution. In this manner, computer system 2101 may obtain application code in the form of a carrier wave.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized storage system with data replication functionality. It is intended that the specification and examples be considered as exemplary only, with a true scope and spirit of the invention being indicated by the following claims.

What is claimed is:

1. A computerized storage system comprising:
a. At least one local storage resource;
b. A network interface operable to connect the computerized storage system with at least one requestor; and
c. A storage controller operable to:
i. receive a request for storage resources from the at least one requester, the request comprising at least one storage resource requirement;
ii. check resource information including information about the at least one local storage resource according to the at least one storage resource requirement;
iii. issue secondary request for storage resources to at least one remote controller at a remote site to check storage resources at the remote site;
iv. collect a reply from the at least one remote controller about available storage resources at the remote site according to the at least one storage resource requirement;
v. select storage resources to be used from the at least one local storage resource and available storage resources at the remote site; and
vi. notify the at least one requestor of the select storage resources.

2. The computerized storage system of claim 1, wherein the at least one requestor is a host computer, a backup server or a tier manager.

3. The computerized storage system of claim 1, wherein the controller is further operable to cause the selected storage resources to be released.

4. The computerized storage system of claim 1 further comprising network optimization controller operable to optimize transfer of data between the computerized storage system and remote storage systems.

5. The computerized storage system of claim 1 further comprising a storage area network interconnecting the at least one local storage resource and the storage controller.

6. The computerized storage system of claim 1 further comprising an extender.

7. The computerized storage system of claim 1, wherein the storage controller further comprises director, cache memory, switch and storage interface controller.

8. The computerized storage system of claim 1, wherein the storage controller operable to:
a. Determine data to be moved to optimize data location;
b. Determine requirements of necessary storage resource for new location of the data;
c. Obtain the necessary storage resource using the determined requirements;
d. Move the data to the obtained storage resource;
e. Change mapping information for the data; and
f. Release an old storage resource corresponding to old location of the data.

9. The computerized storage system of claim 1, wherein the requestor is an application software executing on a computer, the application software operable to:
i. Determine requirements of necessary storage resource;
ii. Generate the request for storage resources to the storage controller;
iii. Receive from the storage controller the notification of the selected storage resources; and
iv. Commence utilization of the selected storage resources.

10. The computerized storage system of claim 1, wherein the requestor is an application software executing on a computer, the application software operable to:
i. Discontinue utilization of the storage resource;
ii. Notify the storage controller of a release of the storage resource; and
iii. Receive notification from the storage controller of completion of release of the storage resource.

11. The computerized storage system of claim 1, wherein the requestor is a backup application executing on a backup server, the backup application operable to:
i. Determine requirements of necessary storage resource;
ii. Generate the request for storage resources to the storage controller;
iii. Receive from the storage controller the notification of the selected storage resources; and
iv. Transfer backup data to the selected storage resources.

12. The computerized storage system of claim 1, wherein the requestor is a backup application executing on a backup server, the backup application operable to:
i. Determine release of at least a portion of backup data and the storage resource;
ii. Notify the storage controller of a release of the storage resource; and
iii. Receive notification from the storage controller of completion of release of the storage resource.

13. The computerized storage system of claim 1, further comprising a graphical user interface illustrating the at least one local storage resource and available storage resources in remote storage systems.

14. A storage controller operable to:
a. receive a request for storage resources from at least one requester, the request comprising at least one storage resource requirement;
b. check resource information including information about at least one local storage resource according to the at least one storage resource requirement;
c. issue secondary request for storage resources to at least one remote controller at a remote site to check storage resources in the remote site;
d. collect at least one reply from the at least one remote controller about available storage resources at a remote site according to the at least one storage resource requirement;
e. select storage resources to be used from the at least one local storage resource and available storage resources at a remote site; and
f. notify the at least one requestor of the select storage resources.

15. The storage controller of claim 14, further operable to:
a. Determine data to be moved to optimize data location;
b. Determine requirements of necessary storage resource for new location of the data;
c. Obtain the necessary storage resource using the determined requirements;
d. Move the data to the obtained storage resource;
e. Change mapping information for the data; and
f. Release an old storage resource corresponding to old location of the data.

16. A method for managing storage resources in multiple sites, the method comprising:
a. Receiving a request for a storage resource from at least one requestor, the request comprising at least one storage resource requirement;
b. Checking resource information including information about at least one local storage resource according to the at least one storage resource requirement;
c. Issuing secondary request for storage resources to at least one remote controller at a remote site to check storage resources at the remote site;
d. Collecting a reply from the at least one remote controller about available storage resources at the remote site according to the at least one storage resource requirement;
e. Selecting storage resources to be used from the at least one local storage resource and available storage resources at the remote site; and
f. Notifying the at least one requestor of the select storage resources.

17. The method of claim 16, wherein the at least one requestor is a host computer, a backup server or a tier manager.

18. The method of claim 16, further comprising selecting storage resources to be released.

19. The method of claim 16, further comprising creating a graphical representation illustrating the at least one local storage resource and available storage resources in remote storage systems.

20. A method for managing location of data in multiple sites, the method comprising:
a. Determining data to be moved to optimize data location;
b. Determining requirements of necessary storage resource for new location of the data;
c. Obtaining necessary storage resources using the determined requirements by selecting the necessary storage resources from the at least one local storage resource and available storage resources at a remote site;
d. Moving the data to the obtained storage resource;
e. Changing mapping information for the data; and
f. Releasing an old storage resource corresponding to old location of the data.

21. A storage controller operable to:
a. Receive a failure message from at least one device in a local site;
b. Choose a destination controller from at least one controller in the local site and at least one controller in a remote site; and
c. Transfer the failure message to the destination controller using a data transfer path dedicated storage system if the destination controller is located in the remote site.

22. A method for processing a failure message from device, the method comprising:
a. Receiving a failure message from at least one device in a local site;
b. Choosing a destination controller from at least one controller in the local site and at least one controller in a remote sites; and
c. Transferring the failure message to the destination controller using a data transfer path dedicated storage system if the destination controller is located in the remote site.

23. A graphical user interface operable to:
a. Display a first category showing types of storage resources;
b. Display the second category showing each site of a plurality of sites; and
c. Show information about storage resources from the first category perspective to the second category.
